(19) United States
(12) Patent Application Publication
(10) Pub. No.: US 2007/0212609 A1
(43) Pub. Date: Sep. 13, 2007

(54) Nonaqueous electrolyte secondary battery

(75) Inventor: Yasunobu Iwami, Moriguchi-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/714,866

(22) Filed: Mar. 7, 2007

(30) Foreign Application Priority Data
Mar. 13, 2006 (JP) 2006-067724

(51) Int. Cl. H01M 4/52

(52) U.S. Cl. 429/231.3; 429/231.6

(57) ABSTRACT

A nonaqueous electrolyte secondary battery according to an embodiment of the present invention includes, as generating elements, a positive electrode 11 which comprises, as a positive electrode, lithium nickel-cobalt-manganese oxide (LiNiₓCo_{y}Mn_{z}O₂) which can intercalate and deintercalate lithium ions or the mixture of lithium nickel-cobalt-manganese oxide (LiNiₓCo_{y}Mn_{z}O₂) and lithium manganese oxide whose amount is 0 to 50% by mass relative to the whole amount of the positive electrode active material, a negative electrode 12 which comprises a negative electrode active material which can intercalate and deintercalate lithium ions, and a nonaqueous electrolyte are provided. To the positive electrode 11, 5 to 20% by mass of lithium cobalt oxide relative to the whole amount of the positive electrode active material is added. Consequently, a nonaqueous electrolyte secondary battery with excellent level of safety is provided by adding an additive which enhances thermal stability, even if lithium nickel-cobalt-manganese oxide is used as a positive electrode active material.

### BACKGROUND

1. Technical Field

The present invention relates to a nonaqueous electrolyte secondary battery which has, as generating elements, a positive electrode having, as a positive electrode active material, a lithium nickel-cobalt-manganese oxide which can intercalate and deintercalate lithium ions or the combination of a lithium nickel-cobalt-manganese oxide and a spinel type lithium manganese oxide, a negative electrode having a negative electrode active material which can intercalate and deintercalate lithium ions, and a nonaqueous electrolyte.

2. Related Art

Recently in applications which require high energy density, a nonaqueous electrolyte secondary battery which uses a nonaqueous electrolyte and which is charged or discharged by having lithium ions move between a positive electrode and a negative electrode has been used as a secondary battery with high energy density. For example, a nonaqueous electrolyte secondary battery has been used as an electric power supply for portable information equipment such as a note PC and a PDA, for visual equipment such as a video camera and a digital camera, or for an electronic telecommunication product such as a mobile phone and a mobile communication product, or as a power source for a hybrid electric vehicle (HEV) and an electric vehicle (EV). Since a nonaqueous electrolyte secondary battery has been used for wide range of applications, there have been demands for further safety.

For a nonaqueous electrolyte secondary battery used in the above-mentioned applications, generally, carbonaceous materials like graphite which can intercalate and deintercalate lithium ions have been used as a negative electrode active material, and lithium cobalt oxide (LiCoO₂), lithium-containing manganese oxide (LiMn₂O₄), or lithium-containing nickel oxide (LiNiO₂) and the like are used as a positive electrode active material. Especially lithium cobalt oxide (LiCoO₂) has been used widely.

On the other hand, attention is recently focusing on lithium nickel-cobalt-manganese oxide (LiNiₓCo_{y}Mn_{z}O₂) as a material for a positive electrode active material, because lithium nickel-cobalt-manganese oxide is superior to lithium cobalt oxide (LiCoO₂) which is the currently most frequently used positive electrode active material for a nonaqueous electrolyte secondary battery, in that lithium nickel-cobalt-manganese oxide has better thermal stability and more theoretical capacity than lithium cobalt oxide, and in that consumption of cobalt which is a rare metal can be less. JP-A-2002-110253 suggests that lithium nickel-cobalt-manganese oxide (LiNiₓCo_{y}Mn_{z}O₂) may be used as a positive electrode active material.

Also, attention is focusing on lithium manganese oxide which has better thermal safety and which does not require cobalt, with a result that the cost is less, but when used alone theoretical capacity and repletion thereof are inferior. Thus, JP-A-2002-110253 suggests that lithium manganese oxide is used along with lithium nickel-cobalt-manganese oxide (LiNiₓCo_{y}Mn_{z}O₂).

### SUMMARY

However, when lithium nickel-cobalt-manganese oxide (LiNiₓCo_{y}Mn_{z}O₂) is used as a positive electrode active material, compared to the use of lithium cobalt oxide (LiCoO₂), the reaction behavior is rapid although the reaction with a nonaqueous electrolyte starts up at higher temperature. Thus, there is a problem that a battery ruptures or ignites once thermorunaway takes place.

When lithium nickel-cobalt-manganese oxide (LiNiₓCo_{y}Mn_{z}O₂) is combined with spinel type lithium manganese oxide, there is a higher level of safety because of the effect of spinel type lithium manganese oxide, but the level of safety is not high enough.

An advantage of some aspects of the present invention is to provide a nonaqueous electrolyte second battery with excellent safety by adding an additive in order to have good thermal stability even when lithium nickel-cobalt-manganese oxide (LiNiₓCo_{y}Mn_{z}O₂) which can intercalate and deintercalate lithium ions is used solely or in combination with spinel type lithium manganese oxide as a positive electrode active material.

A nonaqueous electrolyte secondary battery according to a first aspect of the present invention is provided, as generating elements, with a positive electrode comprising a positive electrode active material which is constituted of lithium nickel-cobalt-manganese oxide (LiNiₓCo_{y}Mn_{z}O₂) that intercalates and deintercalates lithium ions or of lithium nickel-cobalt-manganese oxide (LiNiₓCo_{y}Mn_{z}O₂) in combination with spinel type lithium manganese oxide, a negative electrode comprising a negative electrode active material that intercalates and deintercalates lithium ions, and a nonaqueous electrolyte. To the positive electrode, 5% to 20% by mass of lithium cobalt oxide relative to the whole amount of the positive electrode active material is added.

Thermal stability of a mixed positive electrode active material is enhanced when the mixed positive electrode active material is constituted by adding lithium cobalt oxide to lithium nickel-cobalt-manganese oxide (LiNiₓCo_{y}Mn_{z}O₂) or to lithium nickel-cobalt-manganese oxide (LiNiₓCo_{y}Mn_{z}O₂) in combination with spinel type lithium cobalt oxide, whereby a safe battery can be provided. It is assumed that when temperature of a battery rises for some reason, the added lithium cobalt oxide and the nonaqueous electrolyte start to react at low temperature and a part of a nonaqueous electrolyte in the battery is consumed.

Consequently, when lithium nickel-cobalt-manganese oxide and the nonaqueous electrolyte begin to react, a portion of a nonaqueous electrolyte has already been consumed, thus lithium nickel-cobalt-manganese oxide (LiNiₓCo_{y}Mn_{z}O₂) and the nonaqueous electrolyte react in a mild way. As a result, the temperature where lithium nickel-cobalt-manganese oxide and the nonaqueous electrolyte react in the most rapid way shifts higher. Thus, abnormalities such as rupture and ignition of the battery can be avoided, whereby a battery with excellent safety can be provided.

In this case, if the content of lithium cobalt oxide added is more than 20% by mass relative to the whole amount of the positive electrode active material, the DSC maximum heating temperature enhancement effect is not available. On the other hand, it is found that if the content of lithium cobalt oxide added is 5% or more by mass relative to the whole amount of the positive electrode active material, the DSC maximum heating temperature enhancement effect is available. Thus, it is understood that the preferable amount of lithium cobalt oxide added is 5% or more and 20% or less by mass relative to the whole amount of the positive electrode active material.

It is also known that if the amount of spinel type lithium manganese oxide added is more than 50% by mass relative to the whole amount of the positive electrode active material, the capacity of a battery declines, and if the amount thereof added is 60% or more, a battery can not satisfy a design capacity thereof. Thus, it is understood that the preferable amount of spinel type lithium manganese oxide added is 50% or less by mass relative to the whole amount of the positive electrode active material.

It is preferable that at least one of magnesium (Mg) and aluminum (Al) is added to lithium cobalt oxide. If the amount of Mg or Al added is less than 0.01% by mole relative to cobalt in lithium cobalt oxide, the overcharging characteristic is not enhanced. If the amount of Mg or Al added is more than 3% by mole relative to cobalt in lithium cobalt oxide, the overcharging characteristic is enhanced but on the other hand the load characteristic declines. It is assumed that the excessive additives as oxides cover the surface of an active material but these oxides do not contribute to charging or discharging, and the permittivity thereof is less than that of the active material, resulting in the lower load characteristic.

As described above, in the nonaqueous electrolyte secondary battery according to the present aspect, a mixed positive electrode active material is used which is constituted by adding lithium cobalt oxide to lithium nickel-cobalt-manganese oxide (LiNiₓCo_{y}Mn_{z}O₂) or to lithium nickel-cobalt-manganese oxide in combination with spinel type lithium manganese oxide. Consequently the thermal stability is enhanced and a safe battery can be provided.

### BRIEF DESCRIPTION OF THE DRAWINGS

The invention will be described with reference to the accompanying drawings, wherein like numbers reference like elements.

FIG. 1 is a sectional view illustrating a nonaqueous electrolyte secondary battery according to an embodiment of the invention.

### DESCRIPTION OF EXEMPLARY EMBODIMENTS

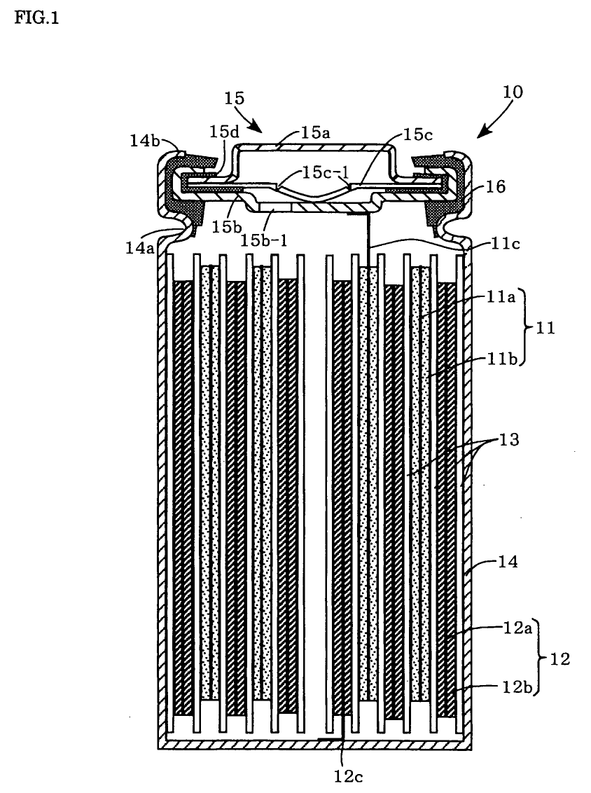

Preferred embodiments of the present invention will now be described. It should be understood however that the embodiments are not intended to limit the present invention. The present invention can be implemented in different modifications without changing advantages of the present invention. FIG. 1 is a sectional view illustrating a nonaqueous electrolyte secondary battery.

### 1. Preparation of Positive Electrode Active Material

### (1) Lithium Nickel-Cobalt-Manganese Oxide (LiNi_{0.333}Co_{0.334}Mn_{0.333}O₂)

First, nickel sulfate (NiSO₄), cobalt sulfate (CoSO₄), and manganese sulfate (MnSO₄) are mixed so that that nickel (Ni): cobalt (Co): manganese (Mn)=0.333:0.334:0.333 by molar ratio. Next, sodium hydrate (NaOH) is added to an aqueous solution of the mixture, and coprecipitated hydroxide is obtained. After this, the coprecipitate and lithium hydroxide (LiOH) are mixed so that the coprecipitate: LiOH=1:1 by molar ratio, and then treated by heat for 12 hours at 750° to 900° C. in an oxygen atmosphere, whereby lithium nickel-cobalt-manganese oxide given by the formula LiNi_{0.333}Co_{0.334}Mn_{0.333}O₂ is obtained. After the heat treating, this resultant material is pulverized into grains of an average diameter 10 μm to serve as a positive electrode active material α.

### (2) Lithium Cobalt Oxide (LiCoO₂)

First, magnesium sulfate (MgSO₄) and aluminum sulfate (Al₂(SO₄)₃)) are added to cobalt sulfate (CoSO₄) solution so that magnesium is 1% and aluminum is 1% by mole relative to cobalt. By adding sodium acid carbonate (NaHCO₃) thereafter, magnesium (Mg) and aluminum (Al) are coprecipitated while cobalt carbonate (CoCO₃) is synthesized. After this, by having them undergo a thermal decomposition reaction, tricobalt tetroxide (Co₃O₄) as an initial raw material for a cobalt source is obtained to which magnesium and aluminum are added.

Next, after preparation of lithium carbonate (Li₂CO₃) as an initial raw material for a lithium source, weighing is performed so that the molar ratio of Li and Co+Mg+Al is 1:1. Then they are mixed and the resultant mixture is fired at 850° C. for 20 hours in an air atmosphere. Thus, a burned substance of lithium cobalt oxide to which Mg and Al are added is synthesized. After this, the synthesized burned substance is pulverized into grains of an average diameter 8 μm to serve as a positive electrode active material β which is constituted of lithium cobalt oxide (LiCoO₂) to which Mg and Al are added. The amount of aluminum (Al) added is measured by ICP (inductively coupled plasma) emission analysis and the amount of magnesium (Mg) added by the atomic absorption method.

### (3) Spinel Type Lithium Manganese Oxide (LiMn₂O₄)

Lithium hydroxide (LiOH) and manganese sulfate (MnSO₄) are mixed so that the molar ratio of lithium (Li) and manganese (Mn) is 1:2. They are then treated by heat at 800° C. for 20 hours in an air atmosphere. Consequently LiMn₂O₄ having the spinel structure is obtained. Further this oxide is pulverized into grains of an average diameter 12 μm to serve as a positive electrode active material y, constituted of spinel type lithium manganese oxide (LiMn₂O₄).

### 2. Preparation of Mixed Positive Electrode Active Material

Next, the positive electrode active materials α (LiNi_{0.333}Co_{0.334}Mn_{0.333}O₂) and β (LiCoO₂ to which Mg and Al are added) are mixed so that the positive electrode active material α is 95% by mass and the positive electrode active material β is 5% by mass, and the resultant mixture serves as a mixed positive electrode active material x1. Separately, the positive electrode active materials α and β are mixed so that the positive electrode active material α is 90% by mass and the positive electrode active material β 10% by mass, and the resultant mixture serves as a mixed positive electrode active material x2. Also, the positive electrode active materials α and β are mixed so that the positive electrode active material α is 80% by mass and the positive electrode active material β is 20% by mass, and the resultant mixture serves as a mixed positive electrode active material x3. Further, the positive electrode active materials α and β are mixed so that the positive electrode active material αis 75% by mass and the positive electrode active material β 25% by mass, the resultant mixture serves as a mixed positive electrode active material x4.

Further, the positive electrode active material a (LiNi_{0.333}Co_{0.334}Mn_{0.333}O₂) and the positive electrode active material γ (spinel type LiMn₂O₄) are mixed so that the positive electrode active material α is 70% by mass and the positive electrode active material γ 30% by mass, and the resultant mixture serves as a mixed positive electrode active material y1. Separately, the positive electrode active materials α, β and γ are mixed so that the positive electrode active material α is 65% by mass, the positive electrode active material β 5% by mass, and the positive electrode active material γ 30% by mass, and the resultant mixture serves as a mixed positive electrode y2. Also, the positive electrode active materials α, β, and γ so that the positive electrode active material α is 60% by mass, the positive electrode active material β 10% by mass, and the positive electrode active material γ 30% by mass, and the resultant mixture serves as a mixed positive electrode active material y3. Further, the positive electrode active materials α, β, and γ are mixed so that the positive electrode active material α is 50% by mass, the positive electrode active material β 20% by mass, and the positive electrode active material γ 30% by mass, and the resultant mixture serves as a mixed positive electrode active material y4. Still further, the positive electrode active materials α, β, and γ are mixed so that the positive electrode active material α is 45% by mass, the positive electrode active material β 25% by mass, and the positive electrode active material γ 30% by mass, and the resultant mixture serves as a mixed positive electrode active material y5.

The positive electrode active materials α (LiNi_{0.333}Co_{0.334}Mn_{0.333}O₂) and γ (spinel type LiMn₂O₄) are mixed so that the positive electrode active material α is 50% by mass and the positive electrode active material γ 50% by mass, and the resultant mixture serves as a mixed positive electrode active material z1. Separately, the positive electrode active materials α, β, and γ are mixed so that the positive electrode active material α is 45% by mass, the positive electrode active material β 5% by mass, and the positive electrode active material γ 50% by mass, and the resultant mixture serves as a mixed positive electrode active material z2. Also, the positive electrode active materials α, β, and γ are mixed so that the positive electrode active material α is 40% by mass, the positive electrode active material β 10% by mass, and the positive electrode active material γ 50% by mass, and the resultant mixture serves as a mixed positive electrode active material z3. Further, the positive electrode active materials α, β, γ are mixed so that the positive electrode active material α is 30% by mass, the positive electrode active material β 20% by mass, and the positive electrode active material γ 50% by mass, and the resultant mixture serves as a mixed positive electrode active material z4. Still further, the positive electrode active materials α, β, and γ are mixed so that the positive electrode active material α is 25% by mass, the positive electrode active material β 25% by mass, and the positive electrode active material γ 50% by mass, and the resultant mixture serves as a mixed positive electrode active material z5.

Further, the positive electrode active materials α, β, and γ are mixed so that the positive electrode active material α is 35% by mass, the positive electrode active material β 5% by mass, and the positive electrode active material γ 60% by mass, and the resultant mixture serves as a mixed positive electrode active material w1. Separately, the positive electrode active materials α, β, and γ are mixed so that the positive electrode active material α is 30% by mass, the positive electrode active material β 10%, and the positive electrode active material γ 60% by mass, and the resultant mixture serves as a mixed positive electrode active material w2. Also, the positive electrode active materials α, β, and γ are mixed so that the positive electrode active material α is 20% by mass, the positive electrode active material β 20% by mass, and the positive electrode active material γ 60% by mass, and the resultant mixture serves as a mixed positive electrode active material w3.

### 3. Preparation of Positive Electrode Plate

Next, each of the thus-prepared mixed positive electrode active materials x1 to x4, y1 to y5, z1 to z5, w1 to w3, and positive electrode active material α, carbon powder to serve as a conductive agent, and polyvinylidene fluoride powder to serve as a binder are mixed so that each of the above-mentioned active material constitutes 90 parts by mass, the carbon powder 5 parts by mass, and the polyvinylidene fluoride powder 5 parts by mass. The resultant mixture serves as a positive electrode mix. N-methyl-2-pyrrolidone (NMP) is added to each of the resultant positive electrode mixes, whereby a positive electrode slurry is obtained.

The slurry thus obtained is applied to both sides of a 20 μm thick aluminum foil (positive electrode substrate) 11a by the doctor blade method, to form a positive electrode active material layer 11b on both sides of the positive electrode substrate 11a. After being dried, the positive electrode substrate 11a is compressed by using a compression roller into a predetermined load density. Then the positive electrode substrate 11a is cut into a predetermined sized piece, thus positive electrode plates 11 (a1 to a4, b1 to b5, c1 to c5, d1 to d3, and e) are prepared. An aluminum alloy foil can be also used as the positive electrode substrate 11a instead of the aluminum foil.

Here the positive electrode plates a1 to a4 are prepared by using the mixed positive electrode active materials x1 to x4, respectively. The positive electrode plates b1 to b5 are prepared by using the mixed positive electrode active materials y1 to y5, respectively. The positive electrode plates c1 to c5 are prepared by using the mixed positive electrode active materials z1 to z5, respectively. The positive electrode plates d1 to d3 are prepared by using the mixed positive electrode active materials w1 to w3, respectively. The positive electrode plate e is prepared by using the positive electrode active material α. The thus prepared positive electrode plates 11 are shown in Table 1.

TABLE 1

| Positive | | Contents of positive electrode | | |
|---|---|---|---|---|
| elec- | | active materials (% by mass) | | |
| trode | Active | α | β | γ |
| plate | material | (LiNi_{0.333}Co_{0.334}Mn_{0.333}O₂) | (LiCoO₂) | (LiMn₂O₄) |
| a1 | x1 | 95 | 5 | 0 |
| a2 | x2 | 90 | 10 | 0 |
| a3 | x3 | 80 | 20 | 0 |
| a4 | x4 | 75 | 25 | 0 |
| b1 | y1 | 70 | 0 | 30 |
| b2 | y2 | 65 | 5 | 30 |
| b3 | y3 | 60 | 10 | 30 |
| b4 | y4 | 50 | 20 | 30 |
| b5 | y5 | 45 | 25 | 30 |
| c1 | z1 | 50 | 0 | 50 |
| c2 | z2 | 45 | 5 | 50 |
| c3 | z3 | 40 | 10 | 50 |
| c4 | z4 | 30 | 20 | 50 |
| c5 | z5 | 25 | 25 | 50 |
| d1 | w1 | 35 | 5 | 60 |
| d2 | w2 | 30 | 10 | 60 |
| d3 | w3 | 20 | 20 | 60 |
| e | α | 100 | 0 | 0 |

### 4. Preparation of Negative Electrode Plate

Natural graphite powder and polyvinylidene fluoride (PVDF) powder to serve as a binder are mixed so that natural graphite power constitutes 95 parts by mass and polyvinylidene fluoride powder 5 parts by mass. Then N-methyl-2-pyrrolidone (NMP) is mixed to the resultant mixture to serve as a negative electrode slurry. Afterward, the negative electrode slurry thus obtained is applied to both sides of a 10 μm thick copper foil (a negative electrode substrate) 12a by the doctor blade method, to form a negative electrode active material layer 12b. After being dried, the negative electrode substrate 12b is compressed by using a compression roller into a predetermined load density. Then the negative electrode substrate 12b is cut into a predetermined sized piece, thus a negative electrode plate 12 is prepared. It is noted that carbon-based materials which intercalate and deintercalate lithium ions, such as artificial graphite, carbon black, coke, glassy carbon, and carbon fiber, or burned substance of these materials can also be used as the negative electrode active material instead of natural graphite.

### 5. Preparation of Lithium Secondary Battery

Next, each of the positive electrode plates 11 (a1 to a4, b1 to b5, c1 to c5, d1 to d3, and e) and negative electrode plate 12 are laminated with a separator 13 constituted of a polypropylene microporous membrane disposed therebetween. They are then wound spirally using a winding machine, thus spiral electrode groups are obtained. Next, each of these spiral electrode groups is inserted into a cylindrical metal case 14, and a negative electrode collection tab 12c extended from the negative electrode plate 12 is welded to the inside bottom of the cylindrical metal case 14. Subsequently, drawing processing is performed around the upper circumference of the cylindrical metal case 14, thus a drawn part 14a is formed.

Afterward, a sealing body 15 is prepared which is constituted of a cap-shaped positive electrode terminal 15a and a positive electrode lid 15b, and a collection tab 11c extended from the positive electrode plate 11 is welded to the bottom of the positive electrode lid 15b. In a portion of the positive electrode lid 15b, a through-hole 15b-1 is provided. Provided inside the space enclosed by the positive electrode terminal 15a and the positive electrode lid 15b is a conductive elastic deformation disk (rupture disk) 15c which is deformed when the gas pressure of the interior portion of the battery rises and reaches a first pressure. The conductive elastic deformation disk 15c serves as a valve member, and a part of the dome portion thereof is fixed to the positive electrode lid 15b by a method such as welding. Also, a notch 15c-1 is formed in a part of the dome portion.

Consequently, the conductive elastic deformation disk 15c is deformed when the gas pressure of the interior portion of the battery rises and reads the first pressure or more, with a result that the part fixed by a method such as welding is separated and the connection between the conductive elastic deformation disk 15c and the positive electrode lid 15b is cutoff. Thus, overcurrent or short circuit current will be blocked. If the gas pressure of the interior portion of the battery further rises and reads a second pressure or more even after overcurrent or short circuit current is blocked, then the notch 15c-1 provided to the conductive elastic deformation disk 15c is cleaved and gas will be released from a gas outlet (not shown) formed on the positive electrode cap 15a. The positive electrode cap 15a and the conductive elastic deformation disk 15c are fixed to each other by means of the positive electrode lid 15b with a first insulated gasket 15d disposed therebetween. A second insulated gasket 16 is provided on the circumference of these elements.

Next, a nonaqueous electrolyte prepared by dissolving 1 mol/L of LiPF₆ in a solvent mixture which contains an equal volume of ethylene carbonate (EC) and diethyl carbonate (DEC) is poured into the cylindrical metal case 14. Disposed afterward on the drawn part 14 formed around the upper circumference of the cylindrical metal case 14 is the sealing body 15 to which a ring-shaped insulated gasket 16 is provided around its circumference. Afterward, the top edge 14b of the metal case 14 is caulked to the side of the sealing body 15 and sealed up. Thus, nonaqueous electrolyte secondary batteries 10 (A1 to A4, B1 to B5, C1 to C5, D1 to D3, and E) each having a diameter of 18 mm and a height (length) of 65 mm are prepared.

The nonaqueous electrolyte secondary battery A1 is prepared using the positive electrode plate a1. The nonaqueous electrolyte secondary battery A2 is prepared using the positive electrode plate a2. The nonaqueous electrolyte secondary battery A3 is prepared using the positive electrode plate a3. The nonaqueous electrolyte secondary battery A4 is prepared using the positive electrode plate a4. The nonaqueous electrolyte secondary battery B1 is prepared using the positive electrode plate b1. The nonaqueous electrolyte secondary battery B2 is prepared using the positive electrode plate b2. The nonaqueous electrolyte secondary battery B3 is prepared using the positive electrode plate b3. The nonaqueous electrolyte secondary battery B4 is prepared using the positive electrode plate b4. The nonaqueous electrolyte secondary battery B5 is prepared using the positive electrode plate b5. The nonaqueous electrolyte secondary battery C1 is prepared using the positive electrode plate c1. The nonaqueous electrolyte secondary battery C2 is prepared using the positive electrode plate c2. The nonaqueous electrolyte secondary battery C3 is prepared using the positive electrode plate c3. The nonaqueous electrolyte secondary battery C4 is prepared using the positive electrode plate c4. The nonaqueous electrolyte secondary battery C5 is prepared using the positive electrode plate c5. The nonaqueous electrolyte secondary battery D1 is prepared using the positive electrode plate d1. The nonaqueous electrolyte secondary battery D2 is prepared using the positive electrode plate d2. The nonaqueous electrolyte secondary battery D3 is prepared using the positive electrode plate d3. The nonaqueous electrolyte secondary battery E is prepared using the positive electrode plate e.

Instead of the solvent mixture prepared by mixing the above-mentioned ethylene carbonate (EC) and diethyl carbonate (DEC), an aprotic solvent can be also used which cannot provide hydrogen ions. For example, organic solvents such as propylene carbonate (PC), vinylene carbonate (VC), and butylene carbonate (BC), or solvent mixtures made up of these carbonates and low boiling point solvents such as diethyl carbonate (DMC), methyl ethyl carbonate (EMC), 1,2-diethoxyethane (DEE), 1,2-dimethoxyethane (DME), and ethoxy methoxy ethane (EME) can be also used. As solutes dissolved in these solvents, LiBF₄, LiCF₃SO₃, LiAsF₆, Lin(CF₃SO₂)₂, LiC(CF₃SO₂)₃, and LiCF₃(CF₂)₃SO₃ can be also used instead of LiPF₆.

### 6. Measurement of Battery Characteristics

### (1) Thermal Analysis of Charged Positive Electrode (Measurement of DSC Maximum Heating Temperature)

Next, with each of the batteries A1 to A4, B1 to B5, C1 to C5, D1 to D3, and E, constant current charging is performed at 25° C. with a charging current of 1800 mA until the battery voltage reaches 4.3 V. Then constant voltage charging is performed with a constant voltage of 4.3 V until a terminal current of 36 mA is achieved. Thereafter, each of these batteries is dismantled in a dry box to obtain the positive electrode plate, which is then washed with diethyl carbonate and is dried in a vacuum, and a test specimen is thus obtained. Two milligrams of ethylene carbonate is added to 5 mg of each of the test specimens thus obtained, and each test specimen is sealed in an aluminum cell in an argon atmosphere. Thereafter, these cells are put in a differential scanning calorimeter (DSC), and heated up with a rate of temperature rise of 5° C./min. Here, a temperature with a maximum self-heating value (mW/mg) of each test specimen (DSC maximum heating temperature) was measured. The measurements are shown in Table 2.

### (2) Initial Capacity

With each of these batteries A1 to A4, B1 to B5, C1 to C5, D1 to D3, and E, constant current charging is performed at 25° C. with a charging current of 1800 mA until the battery voltage reaches 4.2 V. Then constant voltage charging is performed with a constant voltage of 4.2 V until a terminal current of 36 mA is achieved. Thereafter, each battery is discharged with a discharging current of 1800 mA until the battery voltage reaches 2.75 V. In this way only 1 cycle of charging and discharging is performed. Here, the discharge capacity (initial capacity) after one cycle was measured. The results are shown in Table 2.

### (3) Overcharging Test

With each of these batteries A1 to A4, B1 to B5, C1 to C5, D1 to D3, and E, constant current charging is performed at 25° C. with a charging current of 1800 mA until the battery voltage reaches 12 V. Then constant voltage charging is performed starting at 12 V. Here, in this overcharging test, safety of overcharging was evaluated based on whether abnormalities such as smoke emission, ignition, and rupture occur with each battery. The results are shown in Table 2 below. As far as batteries commonly available on the market are concerned, a safety apparatus such as a protection circuit is provided to the batteries themselves or their packs. Consequently there is no room for these dangerous conditions to take place.

Referring to Table 2 below, the batteries D1 to D3 did not reach the design capacity, thus DSC maximum heating temperature thereof was not measured or overcharging test thereof was not performed.

TABLE 2

| | Contents | | | | | |
|---|---|---|---|---|---|---|
| | of positive | | | | | |
| | electrode | | | Battery | DSC max | # Smoke |
| | active materials | | | initial | heating | emission, |
| | (% by mass) | | | capacity | temperature | ignition, |
| Battery | α | β | γ | (mAh) | (° C.) | rupture |
| A1 | 95 | 5 | 0 | 1869 | 231 | 0/10 |
| A2 | 90 | 10 | 0 | 1866 | 235 | 0/10 |
| A3 | 80 | 20 | 0 | 1858 | 229 | 0/10 |
| A4 | 75 | 25 | 0 | 1855 | 170 | 5/10 |
| B1 | 70 | 0 | 30 | 1882 | 212 | 1/10 |
| B2 | 65 | 5 | 30 | 1878 | 242 | 0/10 |
| B3 | 60 | 10 | 30 | 1874 | 250 | 0/10 |
| B4 | 50 | 20 | 30 | 1866 | 249 | 0/10 |
| B5 | 45 | 25 | 30 | 1862 | 172 | 2/10 |
| C1 | 50 | 0 | 50 | 1791 | 210 | 2/10 |
| C2 | 45 | 5 | 50 | 1802 | 240 | 0/10 |
| C3 | 40 | 10 | 50 | 1805 | 255 | 0/10 |
| C4 | 30 | 20 | 50 | 1812 | 235 | 0/10 |
| C5 | 25 | 25 | 50 | 1811 | 177 | 4/10 |
| D1 | 35 | 5 | 60 | 1703 | Not | Not |
| | | | | | measured | measured |
| D2 | 30 | 10 | 60 | 1677 | Not | Not |
| | | | | | measured | measured |
| D3 | 20 | 20 | 60 | 1683 | Not | Not |
| | | | | | measured | measured |
| E | 100 | 0 | 0 | 1873 | 194 | 2/10 |

As it is clearly shown in Table 2 above, it is understood that by comparing the batteries E, B1, and C1 having the positive electrodes e, b1, and c1, respectively, to which the positive electrode active material β (LiCoO₂) is not added with the batteries A1 to A3, B2 to B4, and C2 to C4 having the positive electrodes a1 to a3, b2 to b4, c2 to c4, respectively, to which the positive electrode active material β (LiCoO₂) is added by 5 to 20% by mass, the batteries A1 to A3, B2 to B4, C2 to C4 have higher DSC maximum heating temperature. Furthermore, none of their test specimens ended up smoke emission, ignition, or rupture, which proves that their overcharging test resistance characteristics are enhanced.

If 5 to 20% by mass of the positive electrode active material β (LiCoO₂) is added to the positive electrode active material α (LiNi_{0.333}Co_{0.334}Mn_{0.333}O₂), and if the temperature of the battery rises, of the added LiCoO₂ and the nonaqueous electrolyte react at a low temperature, thus a part of the nonaqueous electrolyte in the battery will be consumed. Consequently, when LiNi_{0.333}Co_{0.334}Mn_{0.333}O₂ and the nonaqueous electrolyte begin to react, a part of the nonaqueous electrolyte has been already consumed. As a result, LiNi_{0.333}Co_{0.334}Mn_{0.333}O₂ and the nonaqueous electrolyte will react in a mild way. Consequently it is assumed that the temperature where LiNi_{0.333}Co_{0.334}Mn_{0.333}O₂ and the nonaqueous electrolyte react in the most rapid way shifts higher.

Even if the positive electrode active material β (LiCoO₂) is added, it is understood that the batteries A4, B5, and C5 having the positive electrodes a4, b5, and c5, respectively, to which 25% by mass of the positive electrode active material β (LiCoO₂) is added have lower overcharging test resistance characteristic because the batteries A4, B5, and C5 have lower DSC maximum heating temperature and more occurrences of smoke emission, ignition, and rupture, namely lowered overcharging test resistance characteristics, in comparison with the batteries E, B1, and C1. It is assumed that because the amount of added LiCoO₂ increases, the reaction of LiCoO₂ and the nonaqueous electrolyte also increases. Consequently, the calorific value due to the reaction of LiCoO₂ and the nonaqueous electrolyte rises, resulting in having the reaction of LiNi_{0.333}Co_{0.334}Mn_{0.333}O₂ and the nonaqueous electrolyte take place earlier than what it should be, following the reaction of LiCoO₂ and the nonaqueous electrolyte.

Considering all these points, it is preferable that the amount of lithium cobalt oxide (LiCoO₂) added is 5% or more and 20% or less by mass relative to the whole amount of the positive electrode active material.

Further, it is understood that the batteries B2 to B4 and C2 to C4 having the positive electrodes b2 to b4 and c2 to c4, respectively, to which the positive active materials β (LiCoO₂) and γ (spinel type LiMn₂O₄) are added have higher DSC heat starting temperature (° C.) in comparison with the batteries A1 to A3 having the positive electrodes a1 to a3, respectively, to which only the positive electrode active material β (LiCoO₂) is added. However the batteries D1 to D3 having the positive electrodes d1 to d3, respectively, to which 60% by mass of the positive electrode active material γ (spinel type LiMn₂O₄) relative to the whole amount of the positive electrode active material is added have the initial battery capacity lower than a predetermined design capacity.

It is because of the lower theoretical capacity and packing of spinel type lithium manganese oxide (LiMn₂O₄), and a packing density necessary to satisfy the design capacity is not obtained. It is understood that the amount of spinel type lithium manganese oxide (LiMn₂O₄) added is preferably 50% or less by mass relative to the whole amount of the positive electrode active material.

### 7. Study on Amount of Mg and Al Added to Lithium Cobalt Oxide (LiCoO₂)

Next the amount of magnesium (Mg) and aluminum (Al) added to lithium cobalt oxide (LiCoO₂) is studied as below.

Magnesium sulfate (MgSO₄) is added to cobalt sulfate (CoSO₄) solution so that magnesium is 0.005% by mole relative to cobalt, thereafter by adding sodium acid carbonate (NaHCO₃), magnesium (Mg) is coprecipitated while cobalt carbonate (CoCO₃) is synthesized. Then, by having these materials undergo thermal decomposition, as an initial raw material for the cobalt source, tricobalt tetroxide (Co₃O₄) to which magnesium is added is obtained. Next, lithium carbonate (Li₂CO₃) as an initial raw material for the lithium source is prepared, and they are weighed so that the molar ratio of Li and Co+Mg is 1:1. Thereafter, all these are mixed, and the resultant mixture is fired at 850° C. for 20 hours. Thus, a burned substance of lithium cobalt oxide to which Mg is added is synthesized. After this, the synthesized burned substance is pulverized into grains of an average diameter 8 μm, which serves as a positive electrode active material β1 constituted of lithium cobalt oxide (LiCoO₂) to which 0.005% by mole of Mg is added is prepared.

Magnesium sulfate (MgSO₄) is added to cobalt sulfate (CoSO₄) solution so that magnesium is 0.01% by mole relative to cobalt. Thereafter a positive electrode active material β2 constituted of lithium cobalt oxide (LiCoO₂) to which 0.01% by mole of Mg is added is prepared in the same way as described above. Also, magnesium sulfate (MgSO₄) is added to cobalt sulfate (CoSO₄) solution so that magnesium is 1% by mole relative to cobalt. Thereafter a positive electrode active material β3 constituted of lithium cobalt oxide (LiCoO₂) to which 1% by mole of Mg is added is prepared in the same way as described above. Further, magnesium sulfate (MgSO₄) is added to cobalt sulfate (CoSO₄) solution so that magnesium is 3% by mole relative to cobalt. Thereafter a positive electrode active material β4 constituted of lithium cobalt oxide (LiCoO₂) to which 3% by mole of Mg is added is prepared in the same way as described above. Still further, magnesium sulfate (MgSO₄) is added to cobalt sulfate (CoSO₄) solution so that magnesium is 4% by mole relative to cobalt. Thereafter a positive electrode active material β5 constituted of lithium cobalt oxide (LiCoO₂) to which 4% by mole of Mg is added is prepared in the same way as described above.

On the other hand, aluminum sulfate (Al₂(SO₄)₃) is added to cobalt sulfate (CoSO₄) solution so that aluminum is 0.005% by mole relative to cobalt. Thereafter, by adding sodium acid carbonate (NaHCO₃), aluminum (Al) is coprecipitated while cobalt carbonate (CoCO₃) is synthesized. Then, by having these undergo thermal decomposition, as an initial raw material for the cobalt source, tricobalt tetroxide (Co₃O₄) to which aluminum (Al) is added is obtained. Next lithium carbonate (Li₂CO₃) as an initial raw material for the lithium source is prepared, and they are weighed so that the molar ratio of Li and Co+Al is 1:1. Thereafter, all these are mixed, and the resultant mixture is fired at 850° C. for 20 hours. Thus, a burned substance of lithium cobalt oxide to which Al is added is synthesized. After this, the synthesized burned substance is pulverized into grains of an average diameter 8 μm to serve as a positive electrode active material β6 constituted of lithium cobalt oxide (LiCoO₂) to which 0.005% by mole of Al is added is prepared.

Separately, aluminum sulfate (Al₂(SO₄)₃) is added to cobalt sulfate (CoSO₄) solution so that aluminum is 0.01% by mole relative to cobalt. Thereafter a positive electrode active material β7 constituted of lithium cobalt oxide (LiCoO₂) to which 0.01% by mole of Al is added is prepared in the same way as described above. Also, aluminum sulfate (Al₂(SO₄)₃) is added to cobalt sulfate (CoSO₄) solution so that aluminum is 1% by mole relative to cobalt. Thereafter a positive electrode active material β8 constituted of lithium cobalt oxide (LiCoO₂) to which 1% by mole of Al is added is prepared in the same way as described above. Further, aluminum sulfate (Al₂(SO₄)₃) is added to cobalt sulfate (CoSO₄) solution so that aluminum is 3% by mole relative to cobalt. Thereafter a positive electrode active material β9 constituted of lithium cobalt oxide (LiCoO₂) to which 3% by mole of Al is added is prepared in the same way as described above. Still further, aluminum sulfate (Al₂(SO₄)₃) is added to cobalt sulfate (CoSO₄) solution so that aluminum is 4% by mole relative to cobalt. Thereafter a positive electrode active material β10 constituted of lithium cobalt oxide (LiCoO₂) to which 4% by mole of Al is added is prepared in the same way as described above.

Separately, without adding magnesium sulfate (MgSO₄) or aluminum sulfate (Al₂(SO₄)₃) to cobalt sulfate (CoSO₄) solution, a positive electrode active material β0 constituted of lithium cobalt oxide (LiCoO₂) to which Mg or Al is not added.

The positive electrode active material a (LiNi_{0.333}Co_{0.334}Mn_{0.333}O₂) and each of the positive electrode active materials β1 to β5, β6 to β10, β, and β0 are mixed so that the positive electrode active material a constitutes 90% by mass and each of the positive electrode active materials β1 to β5, β6 to β10, β, and β0 10% by mass. Thus, there are prepared mixed positive electrode active materials s1 to s5 which comprise the positive electrode active materials β1 to β5, respectively, mixed positive electrode active materials t1 to t5 which comprise the positive electrode active materials β6 to β10, respectively, a mixed positive electrode active material x2 which comprises the positive electrode active material β, and a mixed positive electrode active material v which comprises the positive electrode active material β0. Thereafter, there are produced positive electrode plates 11f1 to 11f5 which comprise the mixed positive electrode active materials s1 to s5, respectively, positive electrode plates 11g1 to 11g5 which comprise the mixed positive electrode active materials respectively t1 to t5, respectively, a positive electrode plate 11a2 which comprises the mixed positive electrode active material x2, and a positive electrode plate 11i which comprises the mixed positive electrode active material v in the same way as described above. Further nonaqueous electrode secondary batteries F1 to F5, G1 to G5, A2, and I are respectively prepared in the same way as described above.

Here, with each of the nonaqueous electrode secondary batteries F1 to F5, G1 to G5, A2, and I, the DSC maximum heating temperature and the initial capacity were measured and overcharging test were performed. The results are shown in Table 3 below.

### Measurement of Load Characteristics

With each of the batteries F1 to F5, G1 to G5, A2, and I prepared in the method described above, constant current charging is performed at 25° C. with a charging current of 1800 mA until the battery voltage reaches 4.2 V. Then constant voltage charging is performed with a constant voltage of 4.2 V until a terminal current of 36 mA is achieved. Thereafter each battery is discharged with a current of 1800 mA until the battery voltage reaches 2.75 V. Here, the discharge capacity after one cycle was measured. The charging is performed in the same way as the first cycle, and discharging is performed with a current of 5400 mA until the battery voltage reaches 2.75 V. Here again, the discharge capacity after two cycles was measured. The ratios of the discharge capacity after one cycle to the discharge capacity after two cycles are shown in Table 3 below.

TABLE 3

| | Contents of | | | | | | | |
|---|---|---|---|---|---|---|---|---|
| | positive | | | | | | | |
| | electrode | | Amount of | | | | | |
| | active | | additives in | | | | | |
| | materials | | LiCoO₂ | | Battery | DSC max | # Smoke | |
| | α (% | β (% | Mg | Al | initial | heating | emission, | Load |
| | by | by | (mole | (mole | capacity | temperature | ignition, | characteristics |
| Battery | mass) | mass) | %) | %) | (mAh) | (° C.) | rupture | (%) |
| I | 90 | 10 | 0 | 0 | 1866 | 190 | 3/10 | 95 |
| F1 | 90 | 10 | 0.005 | 0 | 1868 | 193 | 3/10 | 97 |
| F2 | 90 | 10 | 0.01 | 0 | 1867 | 224 | 0/10 | 98 |
| F3 | 90 | 10 | 1 | 0 | 1864 | 231 | 0/10 | 96 |
| F4 | 90 | 10 | 3 | 0 | 1864 | 235 | 0/10 | 95 |
| F5 | 90 | 10 | 4 | 0 | 1852 | 236 | 0/10 | 92 |
| G1 | 90 | 10 | 0 | 0.005 | 1868 | 195 | 3/10 | 96 |
| G2 | 90 | 10 | 0 | 0.01 | 1867 | 225 | 0/10 | 98 |
| G3 | 90 | 10 | 0 | 1 | 1864 | 229 | 0/10 | 98 |
| G4 | 90 | 10 | 0 | 3 | 1864 | 236 | 0/10 | 97 |
| G5 | 90 | 10 | 0 | 4 | 1854 | 237 | 0/10 | 93 |
| A2 | 90 | 10 | 1 | 1 | 1866 | 235 | 0/10 | 96 |

It is clear from the results shown in Table 3 that the battery I which has the positive electrode plate i with the mixed positive electrode material v containing the positive electrode material β0 constituted of lithium cobalt oxide (LiCoO₂) to which Mg or Al is not added has lower overcharging test resistance as the DSC maximum heating temperature thereof is low and the number of occurrence of smoke emission/ignition/rupture happen is three. It is assumed that lithium cobalt oxide (LiCoO₂) has lower thermal stability when no Mg or Al is added in comparison when Mg or Al is added, with a result that the heating peak and the DSC maximum heating temperature are lower.

On the other hand, as far as the batteries F2 to F5 which have the positive electrode plates f2 to f5, respectively, with the mixed positive electrode active materials s2 to s5, respectively, containing the positive electrode active materials β2 to β5, respectively, constituted of lithium cobalt oxide (LiCoO₂) to which Mg is added, the batteries G2 to G5 which have the positive electrode plates g2 to g5, respectively, with the mixed positive electrode active materials t2 to t5, respectively, each containing the positive electrode active materials β7 to β10, respectively, constituted of lithium cobalt oxide (LiCoO₂) to which Al is added, and the battery A2 which has the positive electrode plate a2 with the mixed positive electrode active material x2 containing the positive electrode active material β consisted of lithium cobalt oxide (LiCoO₂) to which both Mg and Al are added are concerned, it is clear that the overcharging test resistance improves as the number of occurrence of smoke emission/ignition/rupture is zero. It is assumed this is because the thermal stability of lithium cobalt oxide (LiCoO₂) to which at least one of Mg and Al is added is enhanced.

The battery F1 which has the positive electrode plate f1 with the mixed positive electrode active material s1 to which 0.005% by mole of Mg relative to cobalt in lithium cobalt oxide (LiCoO₂) is added has lower DSC maximum heating temperature and lower overcharging resistance in comparison with the batteries F2 to F4 which have the positive electrode plates f2 to f4, respectively, with the mixed positive electrode active materials s2 to s4, respectively, constituted of lithium cobalt oxide to which 0.01 to 3% by mole of Mg relative to cobalt is added. In addition, the battery F5 which has the positive electrode plate f5 with the mixed positive electrode active material s5 to which 4% by mole of Mg relative to cobalt in lithium cobalt oxide (LiCoO₂) is added has lower load characteristics in comparison with the batteries F2 to F4.

Similarly, the battery G1 which has the positive electrode plate g1 with the mixed positive electrode active material t1 constituted of lithium cobalt oxide to which 0.05% by mole of Al relative to cobalt is added has lower DSC maximum heating temperature and lower overcharging resistance in comparison with the batteries G2 to G4 which have the positive electrode plates g2 to g4, respectively, with the mixed positive electrode active materials t2 to t4, respectively, constituted of lithium cobalt oxide to which 0.01 to 3% by mole of Al relative to cobalt is added. In addition, the battery G5 which has the positive electrode plate g5 with the mixed positive electrode active material t5 to which 4% by mole of Al relative to cobalt in lithium cobalt oxide (LiCoO₂) is added has lower load characteristics in comparison with the batteries G2 to G4.

Thus, it is understood that it is preferable that the amount of Mg and Al added is 0.01 to 3% by mole relative to cobalt in lithium cobalt oxide.

In the above-mentioned embodiments, descriptions are made with respect to the examples where LiNi_{0.333}Co_{0.334}Mn_{0.333}O₂ is used as lithium nickel-cobalt-manganese oxide. The similar results can be obtained when lithium nickel-cobalt-manganese oxide given by the formula LiNiₓCo_{y}Mn_{z}O₂ (where 0<x, 0<y≦0.5, 0<z≦0.5, x+y+z=1) is used instead.

With the features of the invention, a nonaqueous electrolyte secondary battery having a high level of safety is provided.

What is claimed is:

1. A nonaqueous electrolyte secondary battery, comprising:
a positive electrode including lithium nickel-cobalt-manganese oxide, as a positive electrode active material, that intercalates and deintercalates lithium ions;
a negative electrode including a negative electrode active material that intercalates and deintercalates lithium ions; and
a nonaqueous electrolyte;
the positive electrode, the negative electrode, and the nonaqueous electrolyte serving as generating elements,
the positive electrode being added with 5 to 20% by mass of lithium cobalt oxide relative to the whole amount of the positive electrode active material, the lithium cobalt oxide being added with at least one of magnesium (Mg) and aluminum (Al).

2. The nonaqueous electrolyte secondary battery according to claim 1, wherein the amount of the magnesium (Mg) to be added is 0.01 to 3% by mole relative to cobalt in the lithium cobalt oxide.

3. The nonaqueous electrolyte secondary battery according to claim 1, wherein the amount of the aluminum (Al) to be added is 0.01 to 3% by mole relative to cobalt in the lithium cobalt oxide.

4. A nonaqueous electrolyte secondary battery, comprising:
a positive electrode including lithium nickel-cobalt-manganese oxide, as a positive electrode active material, that intercalates and deintercalates lithium ions;
a negative electrode including a negative electrode active material that intercalates and deintercalates lithium ions; and
a nonaqueous electrolyte;
the positive electrode, the negative electrode, and the nonaqueous electrolyte serving as generating elements,
the positive electrode being added with 5 to 20% by mass of lithium cobalt oxide relative to the whole amount of the positive electrode active material, the lithium cobalt oxide being added with at least one of magnesium (Mg) and aluminum (Al), and
the positive electrode being further added with 30% or more and 50% or less by mass of spinel type lithium manganese oxide relative to the whole amount of the positive electrode active material.

5. The nonaqueous electrolyte secondary battery according to claim 4, wherein the amount of the magnesium (Mg) to be added is 0.01 to 3% by mole relative to cobalt in the lithium cobalt oxide.

6. The nonaqueous electrolyte secondary battery according to claim 4, wherein the amount of the aluminum (Al) to be added is 0.01 to 3% by mole relative to cobalt in the lithium cobalt oxide.
